(19) United States
(12) Patent Application Publication
(10) Pub. No.: US 2006/0215699 A1
(43) Pub. Date: Sep. 28, 2006

(54) Trick mode operation for subchannels

(76) Inventors: Charles William Worrell, Carmel, IN (US); Mark Alan Logan, Beech Grove, IN (US); Chad Andrew Lefevre, Indianapolis, IN (US)

Correspondence Address: THOMSON LICENSING INC., PATENT OPERATIONS, PO BOX 5312, PRINCETON, NJ, 08543-5312, US

(21) Appl. No.: 10/564,569

(22) PCT Filed: Jul. 7, 2004
(86) PCT No.: PCT/US04/21622

§ 371 Date: Jan. 13, 2006

Related U.S. Application Data
(60) Provisional application No. 60/488,897, filed on Jul. 21, 2003.

(51) Int. Cl. H04J 3/24

(52) U.S. Cl. 370/474; 370/476

(57) ABSTRACT

In a receiver coupled to a recording device that includes a digital storage medium, there is provided a method for providing trick mode operations for sub-channels of multiplexed streams stored on the digital storage medium. A trick mode command specifically directed to a particular sub-channel of a multiplexed stream is sent to the recording device. Frame data corresponding to the particular sub-channel is received from the recording device. Trick mode data for the particular sub-channel is extracted from the frame data.

### BACKGROUND OF THE INVENTION

1. Field of the Invention

The present invention generally relates to multiplexed streams and, more particularly, to a method for providing trick mode operations for multiplexed streams stored on digital storage mediums.

2. Background of the Invention

Many Institute of Electrical & Electronics Engineers (IEEE) 1394-based digital storage devices (e.g., Digital Video Home System (DVHS) recorders, hard drives for Personal Video Recorders (PVRs), and so forth) serve to capture and playback multiplexed streams (e.g., Moving Picture Experts Group (MPEG) transport streams) that often contain multiple video and audio programs. However, current technology does not allow for the implementation of trick mode operations (fast forward, rewind, etc.) upon sub-channels (program within this type of stream that are not the first or “primary” program).

The control of IEEE 1394-based digital storage devices is performed using a command set defined by the Audio/Video Control (AV/C) specifications released by the IEEE 1394 Trade Association. The common specification defines a set of commands for controlling audio/video devices that comply with the IEEE 1394 standard.

Within these specifications are controls to do such things as turn on/off devices, initiate a play, fast-forward, rewind, etc. A major deficiency of this command set is the inability to perform trick mode operations such as fast forward or rewind when the user of the device is watching a sub-channel.

Accordingly, it would be desirable and highly advantageous to have the capability to perform trick mode operations (fast-forward, rewind, etc.) on sub-channels within an MPEG transport stream stored by IEEE-1394-based digital storage mediums.

### SUMMARY OF THE INVENTION

The problems stated above, as well as other related problems of the prior art, are solved by the present invention, which is directed to a method for providing trick mode operations for multiplexed streams stored on digital storage mediums

Advantageously, the present invention allows a digital storage medium (e.g., an IEEE 1394-based digital storage medium to perform trick mode operations (fast-forward, rewind, etc.) on sub-channels within a multiplexed stream such as, e.g., a Moving Picture Experts Group (MPEG) transport stream.

According to an aspect of the present invention, there is provided a method for providing trick mode operations for sub-channels of multiplexed streams stored on a digital storage medium. A trick mode command specifically directed to a particular sub-channel of a multiplexed stream is received by the digital storage medium. Frame data corresponding to the particular sub-channel is identified. Trick mode data for the particular sub-channel is extracted from the frame data.

According to another aspect of the present invention, in a recording device that includes a digital storage medium and that is coupled to a receiver, there is provided a method for providing trick mode operations for sub-channels of multiplexed streams stored on the digital storage medium. A trick mode command specifically directed to a particular sub-channel of a multiplexed stream is received by the recording device from the receiver. In response to receiving the trick mode command, frame data corresponding to the particular sub-channel for extraction of trick mode data there from is sent to the receiver. The trick mode data corresponds to the particular sub-channel.

These and other aspects, features and advantages of the present invention will become apparent from the following detailed description of preferred embodiments, which is to be read in connection with the accompanying drawings.

### BRIEF DESCRIPTION OF THE DRAWINGS

FIG. 1 is a diagram illustrating an MPEG-2 transport stream 100 to which the present invention can be applied, according to an illustrative embodiment of the present invention;

FIG. 2 is diagram illustrating a trick mode method for a multiplexed stream stored on a digital storage medium, according to the prior art;

FIG. 3 is a diagram illustrating a trick mode method for a multiplexed stream stored on a digital storage medium, according to an illustrative embodiment of the present invention; and

FIG. 4 is a diagram illustrating an exemplary Audio Video Control (AV/C) play command for a trick mode operation directed to a sub-channel of a multiplexed stream, according to an illustrative embodiment of the present invention.

### DETAILED DESCRIPTION OF THE INVENTION

The present invention is directed to a method for providing trick mode operations for multiplexed streams stored on digital storage mediums. Advantageously, the present invention allows a display device/decoder and digital storage medium (e.g., an IEEE 1394-based digital storage medium) to perform trick mode operations (fast-forward, rewind, etc.) on sub-channels within a multiplexed stream such as, e.g., a Moving Picture Experts Group (MPEG) transport stream.

For illustrative purposes, the present invention is primarily described with respect to MPEG transport streams and recording devices having an IEEE 1394-based digital storage medium. However, it is to be appreciated that the present invention is not limited to only MPEG transport streams and to IEEE 1394-based digital storage mediums and, thus, can be applied to other types of multiplexed streams and to recording devices having other types of digital storage mediums, while maintaining the spirit and scope of the present invention.

As used herein, the phrase “recording device” applies to any type of device having at least a memory therein for storing digital media. For example, the present invention can be applied to recording devices including, but not limited to, Digital Video Home System (DVHS) recorders and hard drives for Personal Video Recorders (PVRs). Further, as used herein, the term “sub-channel” refers to a program within a digital stream that is not the first or “primar” program of that digital stream.

It is to be understood that the present invention can be implemented in various forms of hardware, software, firmware, special purpose processors, or a combination thereof. Preferably, the present invention is implemented as a combination of hardware and software. Moreover, the software is preferably implemented as an application program tangibly embodied on a program storage device. The application program can be uploaded to, and executed by, a machine comprising any suitable architecture. Preferably, the machine is implemented on a computer platform having hardware such as one or more central processing units (CPU), a random access memory (RAM), and input/output (I/O) interface(s). The computer platform also includes an operating system and microinstruction code. The various processes and functions described herein can either be part of the microinstruction code or part of the application program (or a combination thereof) that is executed via the operating system. In addition, various other peripheral devices can be connected to the computer platform such as an additional data storage device and a printing device.

Alternatively, the present invention can be implemented in hardware circuits within an application specific integrated circuit (ASIC) or a programmable logic device (PLD) such as a field programmable gate array (FPGA).

It is to be further understood that, because some of the constituent system components and method steps depicted in the accompanying Figures are preferably implemented in software, the actual connections between the system components (or the process steps) can differ depending upon the manner in which the present invention is programmed. Given the teachings herein, one of ordinary skill in the related art will be able to contemplate these and similar implementations or configurations of the present invention.

A common use for Institute of IEEE-1394-based digital storage devices is for the recording of digital broadcast audio and video, such as those carried by, e.g., Advanced Television Systems Committee (ATSC), Digital Video Broadcasting (DVB), and Digital Broadcast Systems (DBS). As an example, in the ATSC case, digital audio and video are delivered via MPEG-2 transport stream and then captured to the IEEE 1394-based device for storage and playback.

Most digital television transmissions contain multiple programs (often referred to as multi-casting). In these captured transport streams there are packets of data from several different programs at once. The data necessary to extract one or another program from the transport stream is defined in the Program Specific Information Protocol (PSIP). When the IEEE 1394-based device is playing back the recorded transport stream to an ATSC compatible television receiver, the receiver uses the PSIP to extract only the information that is required for the decoding and display of the program of interest to the user. The other programs on the stream are still delivered to the receiver from the IEEE 1394-based device. This data is merely disregarded by the receiver.

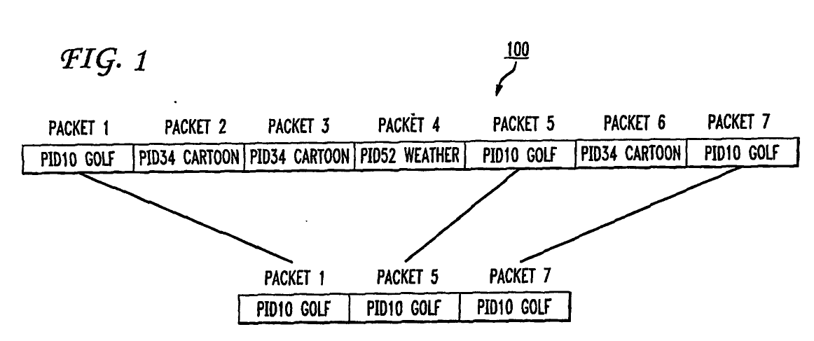

For example, the IEEE 1394-based device can hold a recording containing several video programs: “Golf”, “Cartoons”, “Weather”. Each of these programs is delivered in packets that have unique Packet IDentifiers (PIDs) as described in the PSI. The video for golf can be on PID=10, the video for cartoons on PID=34, and the video for weather on PID=52. FIG. 1 is a diagram illustrating an MPEG-2 transport stream 100 to which the present invention can be applied, according to an illustrative embodiment of the present invention. Thus, the data delivered can appear similar to that shown in FIG. 1 when the user is watching golf.

The MPEG-2 transport stream 100 includes packet 1 through packet 7.

Packets 1, 5, and 7 are used to generate the video. The other packets are discarded. A larger number of packets are required in order to reconstruct a single video frame.

When the user attempts to fast forward, an AV/C command is sent to the IEEE 1394-based device to tell the device to fast forward (FFWD). Due to the limited bandwidth of the interfaces involved and the limited amount of memory available on the receiver, during FFWD only some frames are sent, many frames are skipped.

When the IEEE 1394-based storage device receives the command to FFWD, the device only knows that the user wishes to FFWD. The IEEE 1394-based storage device does not know which program the user is watching. This is because the receiver filters out the video packets for the program that the user wishes to view, not the IEEE 1394-based storage device). Therefore, the IEEE 1394-based storage device must make an assumption about which program for which the storage device will deliver frames. For a generic MPEG-2 stream, the first program listed in the Program Association Table is generally chosen. In general, some intra-coded frames, that include packets with the PIDs associated with the first program, are then delivered. The receiver will receive all of the packets necessary to reconstruct the video for the primary program. However, since all of the packets for the different programs are multiplexed together as shown above, the receiver will also get interspersed snippets of the frames on the others PIDs. This is why FFWD, REW, and so forth are not possible on sub-channels with the current technology.

Under the conditions described herein in which a user is watching a sub-channel and tries to use a trick mode, a conventional receiver will react in one of two ways.

The first way in which a conventional receiver will react in the above situation will now be described. The receiver will know that FFWD has commenced and will revert to the primary program for the duration of the fast-forward. In the example given, if the first program is golf and the user is watching cartoons from the same bit stream, when the user tries to fast forward, the video would switch to golf for the duration of the fast forward, and then revert back to cartoons when normal play is resumed.

The second way in which a conventional receiver will react in the above situation will now be described. The receiver sends the fast forward command to the IEEE 1394-based storage device, and tries to continue playing the current stream. In the example given, if the first program is golf and the user is watching cartoons from the bit stream, when the user tries to fast forward, the only bits and pieces of the data necessary to produce frames for cartoons will be delivered. The result from the receiver will be substantial undesirable MPEG video artifacts, or the receiver can actually interpret the stream as a weak signal and blank the screen.

The present invention advantageously augments the command structure so that the receiver can indicate to the IEEE 1394-based storage device which of the programs on the stream is of interest, and the device can interpret this augmented command to send the proper data during trick mode operation.

Note that the example of an ATSC MPEG-2 transport stream with the three programs has been used for illustrative purposes only. The present invention can be applied to any multiplexed stream captured on a digital storage medium.

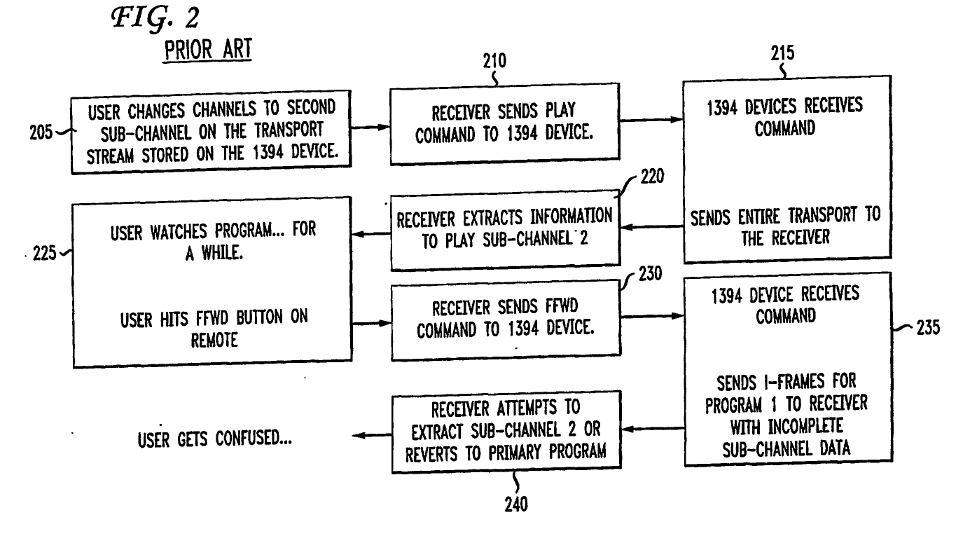

FIG. 2 is diagram illustrating a trick mode method for a multiplexed stream stored on a digital storage medium, according to the prior art.

The user changes channels to a second sub-channel on the transport stream stored on the IEEE 1394-based storage device (step 205). The receiver sends a play command to the IEEE 1394-based storage device (step 210). The IEEE 1394-based storage device receives the command and sends the entire transport stream to the receiver (step 215).

The receiver extracts the information to play sub-channel 2 (step 220). The user watches the program for a while, and then hits the FFWD button on the remote (step 225).

The receiver sends the FFWD command to the IEEE 1394-based storage device (step 230). The IEEE 1394-based storage device receives the FFWD command, and sends I-Frames for program 1 to the receiver with incomplete sub-channel data (step 235).

The receiver attempts to extract sub-channel 2 or reverts to the primary program (step 240), resulting in potential confusion the user.

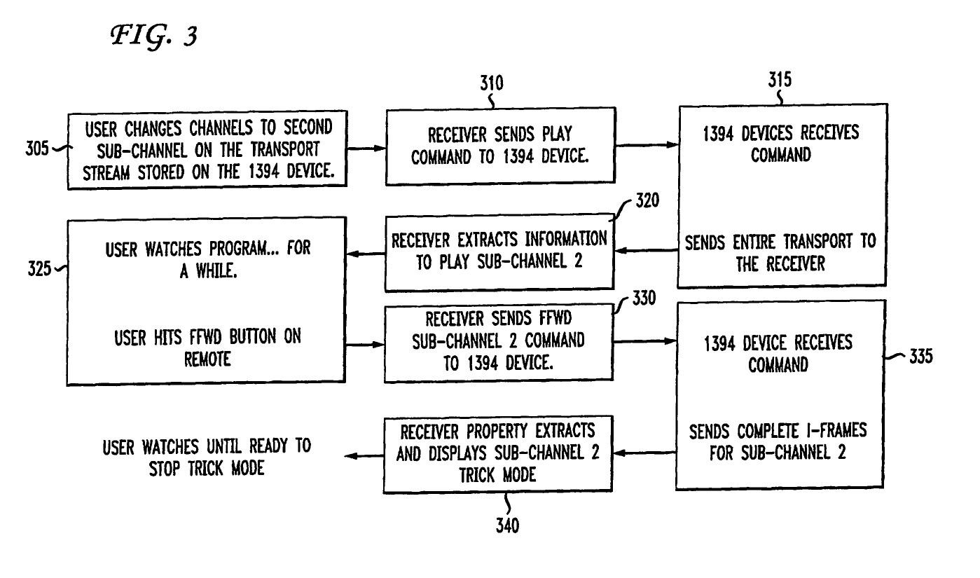

FIG. 3 is a diagram illustrating a trick mode method for a multiplexed stream stored on a digital storage medium, according to an illustrative embodiment of the present invention.

The user changes channels to a second sub-channel on the transport stream stored on the IEEE 1394-based storage device (step 305). The receiver sends a play command to the IEEE 1394-based storage device (step 310). The IEEE 1394-based storage device receives the command and sends the entire transport stream to the receiver (step 315).

The receiver extracts the information to play sub-channel 2 (step 320). The user watches the program for a while, and then hits the FFWD button on the remote (step 325).

The receiver sends the FFWD sub-channel 2 command to the IEEE 1394-based storage device (step 330). The IEEE 1394-based storage device receives the FFWD sub-channel 2 command, and sends I-Frames for sub-channel 2 to the receiver (step 335). I-frames are intra-coded and can be reconstructed with any reference to other frames (unlike P- or B-frames).

The receiver extracts and displays the sub-channel 2 trick mode (step 340), so that the user can continue watching until the user is ready to stop the trick mode.

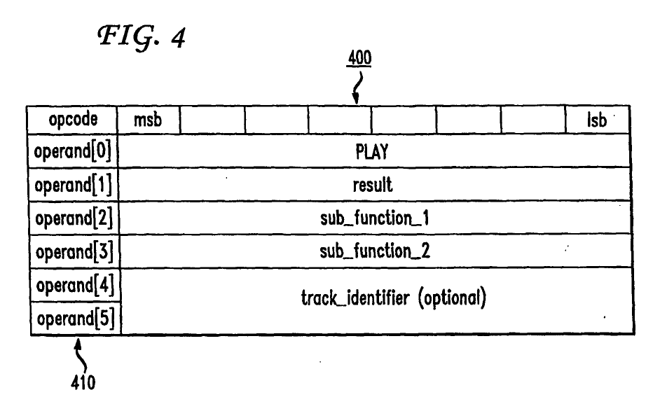

FIG. 4 is a diagram illustrating an exemplary Audio Video Control (AV/C) play command 400 for a trick mode operation directed to a sub-channel of a multiplexed stream, according to an illustrative embodiment of the present invention. The AV/C command 400 is provided in a generic format, and can be implemented with respect to media and devices including, but not limited to, Audio Video disks and a digital VCR. Given the teachings of the present invention provided herein, one of ordinary skill in the related art will readily contemplate various modifications, expansions, and so forth with respect to the AV/C command 400 shown and described with respect to FIG. 4, so as to adapt the command to other media and devices, while maintaining the spirit of the present invention.

The AV/C command 400 includes a plurality of operands 410. Operand[0] specifies a play command. Operand[1] specifies a result.

Operand[2] specifies a first sub-function (sub_function_{—}1). The first sub-function specifies the particular play mode to be applied (including, but not limited to, normal, slow_forward, fast_reverse, and so forth).

Operand[3] specifies a second sub-function (sub_function_{—}2). The value of the second sub-function can vary from zero to the total number of programs including in the multiplexed stream minus 1 (number_of_programs_in_multiplex−1), and specifies which program (sub-channel) to play.

Operand[4] and operand[5] are optional, and are used for Audio Video discs only, where the disc must playback a specific track.

Although the illustrative embodiments have been described herein with reference to the accompanying drawings, it is to be understood that the present invention is not limited to those precise embodiments, and that various other changes and modifications can be affected therein by one of ordinary skill in the related art without departing from the scope or spirit of the invention. All such changes and modifications are intended to be included within the scope of the invention as defined by the appended claims.

1. A method for providing trick mode operations for sub-channels of multiplexed streams stored by a digital storage medium, comprising the steps of:
receiving at the recording device, a trick mode command directed to a particular sub-channel of a multiplexed stream;
identifying frame data stored by the digital storage medium corresponding to the particular sub-channel; and
extracting, from the frame data, trick mode data for the particular sub-channel.

2. The method of claim 1, wherein the frame data comprises complete Intra-coded frames (I-frames) for the particular sub-channel.

3. The method of claim 1, further comprising the step of outputting the trick mode data for the particular sub-channel to a display device for display thereby.

4. The method of claim 1, wherein said receiving step sending step is performed in response to a user selecting the trick mode command via a remote control device.

5. The method of claim 1, wherein the digital storage medium is Institute of Electrical & Electronics Engineers 1394 (IEEE-1394) compliant.

6. The method of claim 1, wherein the multiplexed stream is a Moving Picture Experts Group (MPEG) transport stream.

7. The method of claim 1, wherein the particular sub-channel of the multiplexed stream is specified as an operand in the trick mode command.

8. The method of claim 7, wherein at least one of a plurality of trick mode operations to be applied to the particular sub-channel is specified as another operand in the trick mode command.

9. In combination with a digital storage medium coupled to a receiver, a method for providing trick mode operations for sub-channels of multiplexed streams stored on the digital storage medium, comprising the steps of:
receiving, from the receiver, a trick mode command specifically directed to a particular sub-channel of a multiplexed stream; and
sending, to the receiver, in response to receiving the trick mode command, frame data corresponding to the particular sub-channel stored by the digital storage medium for extraction of trick mode data there from, the trick mode data corresponding to the particular sub-channel.

10. The method of claim 9, wherein the frame data comprises complete Intra-coded frames (I-frames) for the particular sub-channel.

11. The method of claim 9, wherein the digital storage medium is Institute of Electrical & Electronics Engineers 1394 (IEEE-1394) compliant.

12. The method of claim 9, wherein the multiplexed stream is a Moving Picture Experts Group (MPEG) transport stream.

13. The method of claim 9, wherein the particular sub-channel of the multiplexed stream is specified as an operand in the trick mode command.

14. The method of claim 13, wherein at least one of a plurality of trick mode operations to be applied to the particular sub-channel is specified as another operand in the trick mode command.
